(19) United States
(12) Patent Application Publication
(10) Pub. No.: US 2024/0211313 A1
(43) Pub. Date: Jun. 27, 2024

(54) Onboard edge computation device, associated electronic system and method for executing software applications

(71) Applicant: THALES, Meudon (FR)

(72) Inventors: Sébastien RAZE, MERIGNAC (FR); François COULMEAU, TOULOUSE (FR); Bruno CAPELLE, MERIGNAC (FR); Yannick LE ROUX, MERIGNAC (FR); Pierre MARIANI, MERIGNAC (FR)

(21) Appl. No.: 18/542,715

(22) Filed: Dec. 17, 2023

(30) Foreign Application Priority Data
Dec. 22, 2022 (FR) 2214319

(51) Int. Cl. G06F 9/50

(52) U.S. Cl. CPC G06F 9/5027

(57) ABSTRACT

An edge computation device on board an aircraft is configured for communicating with one or a plurality of onboard electronic devices having certified operation, and with at least one remote computation system. Same includes local computational resources, and is configured for implementing a management module for a plurality of software applications suitable for providing at least one control parameter and/or receiving at least one datum from at least one onboard electronic device, a module for activating the execution of at least one of the stored software applications, a management module for an execution stack, configured for determining, for each software application to be executed, an allocation of local computation resources and, where appropriate, for executing locally a first part of the application, and for requesting remote execution, by means of the remote computation system, of a second part of the application to be executed.

### CROSS-REFERENCE TO RELATED APPLICATIONS

This application is a U.S. non-provisional application claiming the benefit of French Application No. 22 14319, filed on Dec. 22, 2022, which is incorporated herein by reference in its entirety.

### TECHNICAL FIELD OF THE INVENTION

The present invention relates to an onboard edge computation device, as well as an associated electronic system for executing software applications and an associated method for executing software applications.

The invention lies in the field of avionics, and more particularly in the field of executing software applications onboard an aircraft.

The invention applies to any type of aircraft, either with or without a pilot onboard, both in a civil or military context.

### BACKGROUND OF THE INVENTION

In a known manner, aircraft include onboard electronic devices (or onboard computation devices) having a certified operation according to an avionics certification standard. More particularly, any software application embedded in such a device has to be compliant and certified. Thereby, onboard software applications which are useful for navigation, for the control of onboard equipment, e.g., various sensors, e.g., optical or thermal cameras, radars, etc., are limited in number, because same are expensive to develop and to certify. In addition, the computing resources (e.g., CPU, ROM, RAM) of the certified onboard computation devices are generally pre-allocated, in order to guarantee security and to limit any risk of hacking or of external intrusion. Thereby, the hardware and software structure of certified onboard computation devices is rigid, any evolution or modification being slow and expensive.

However, the need for computing resources, e.g., processors and memories, for aeronautical operations is constantly increasing, since increasingly sophisticated software applications can advantageously be implemented. In addition, new uses are developing with the advent of new types of lightweight aircraft, e.g., drones or urban taxi aircraft, making it possible in particular to use onboard sensors for new data collection missions, for surveillance, maintenance applications, etc.

Therefore, there is a need to increase the computational capacity of onboard devices in order to run software applications related to such new needs.

Systems for the remote execution of software applications on the ground, in computation centers on the ground, have been proposed. However, insofar as onboard equipment controls and data recovery from such equipment are needed, it is not always possible to use remote applications on the ground, depending on the needs in particular in terms of bandwidth and latency, and, where appropriate, in terms of reliability/integrity of computations and data protection.

There is thus a need to run software applications in connection with equipment onboard an aircraft, which combines the increase in available computational resources and reliability.

### SUMMARY OF THE INVENTION

For this purpose, the invention provides, according to one embodiment, an onboard edge computation device including a first communication interface configured for communicating, according to a first communication protocol, with one or a plurality of onboard electronic devices with certified operation, a second radio communication interface configured for communicating, according to a second radio communication protocol, with the remote computation system located on the ground, the edge computation device including at least one electronic memory unit and at least one computation processor, configured for implementing:
a module for managing a plurality of software applications, the applications being stored in the electronic memory, each software application being suitable for providing at least one control parameter and/or receiving at least one datum from at least one onboard electronic device with certified operation;
a module for activating the execution of at least one of the stored software applications, configured for receiving at least one request for the execution of at least one software application from an external control device and/or for validating an activation condition for the execution of at least one software application; and
a management module for an execution stack, configured for determining, for each software application to be executed, an allocation of local computation resources of the edge computation device, in order to execute all or part of the software application to be executed, and for launching he local execution of the part of the application to be executed and for requesting, in the case where a first part of the application is executed locally, a remote execution, by the remote computation system, of a second part of the application to be executed, complementary to the first part.

Advantageously, such an edge computation device considerably increases the computation resources available on board, while managing the execution of the software application(s) between the local computation resources on board and remote computation resources.

The edge computation device according to the invention may further have one or a plurality of the features below, taken independently or according to all technically feasible combinations.

The module for managing an execution stack implements, for the determination of local computation resources allocated per software application to be executed, at least one criterion among: a criterion of availability of computation resources, a criterion of connectivity, a criterion of data protection, and a criterion of priority.

The device is configured for dynamically receiving, from an external control device, at least one parameter of allocation of computational resources and/or connectivity and/or a priority of execution.

The device further includes a management module for data and results configured for consolidating and storing results obtained by the execution of each software application, for communicating the results to the external control device and/or the remote computation system.

The module for managing a plurality of software applications is configured for downloading new software applications or an update of a previously stored software application and/or for deleting a previously stored software application.

According to another aspect, the invention relates to an electronic execution system for software applications comprising a computation system onboard an aircraft, and at least one remote computation system located on the ground, the onboard computation system including at least one onboard electronic device with certified operation according to an avionics certification standard, and an edge computation device as briefly described hereinabove.

The electronic execution system for software applications may further have one or a plurality of the features below, taken independently or according to all technically conceivable combinations.

The remote computation system further comprises a supervision device including a human-machine interface and being configured for receiving observability signals from the edge computation device, such observability signals comprising data relating to the local computation resources and information on the execution of at least one of the software applications, for calculating a state of operation of the edge computation device and a state of execution of the at least one software application from the received observability signals, and for displaying the state of operation and the state of execution on the human-machine interface.

The edge computation device is configured for recording, during a mission of the aircraft, a set of information in at least one execution report, comprising status and execution information of the edge computation device and of the onboard electronic devices with certified operation, as well as supplementary information comprising information on the environment and information on connectivity, and for sending the execution report to the supervision device, the supervision device being further configured for executing and displaying on the human-machine interface a replay of the states of the edge computation device and of the onboard electronic devices.

According to another aspect, the invention relates to a method for executing software applications, implemented in an electronic system for executing applications of the type described hereinabove, comprising:
receiving a command to add/delete a software application, coming from an external control device, or from the ground computation system or from one of the onboard devices;
updating a storage of software applications according to the command received;
activating the execution of one or a plurality of the stored software applications, based either on the reception of a request to execute at least one software application from an external device, either on the validation of an activation condition for execution and/or pausing or stopping the execution of one or a plurality of software applications upon reception of a command or automatic validation of a stop condition.

According to a particular feature, the method further comprises managing a stack of applications, implementing, for each software application to be executed, an allocation of local computation resources for executing a first part of the software application, and, in the case where the first part is less than 100%, sending a command to execute a second part of the software application, complementary to the first part, to the remote computation system.

According to another aspect, the invention relates to a computer program including software instructions which, when executed by a programmable electronic system, implement a method for executing software applications, as briefly described hereinabove.

### BRIEF DESCRIPTION OF THE DRAWINGS

Other features and advantages of the invention will be clear from the description thereof which is given below as a non-limiting example, with reference to the enclosed figures, among which:

FIG. 1 illustrates an electronic execution system for software applications according to an embodiment;

FIG. 2 illustrates, schematically, a method of execution of software applications according to a first embodiment;

FIG. 3 illustrates a method of execution of software applications according to a second embodiment.

### DETAILED DESCRIPTION

The electronic execution system for software applications onboard an aircraft finds applications in any type of aircraft, and more particularly for lightweight aircraft such as drones, carrying onboard equipment such as image sensors, such as an optical camera, a thermal camera, an imaging radar, positioning sensors (GNSS, inertial units, Pitot-static sensors, radio navigation beacons, triangulation), measurement systems such as rangefinders, weather, traffic or terrain sensors and monitoring systems, radio or digital communication systems, radio frequency (RF) antennas, etc.

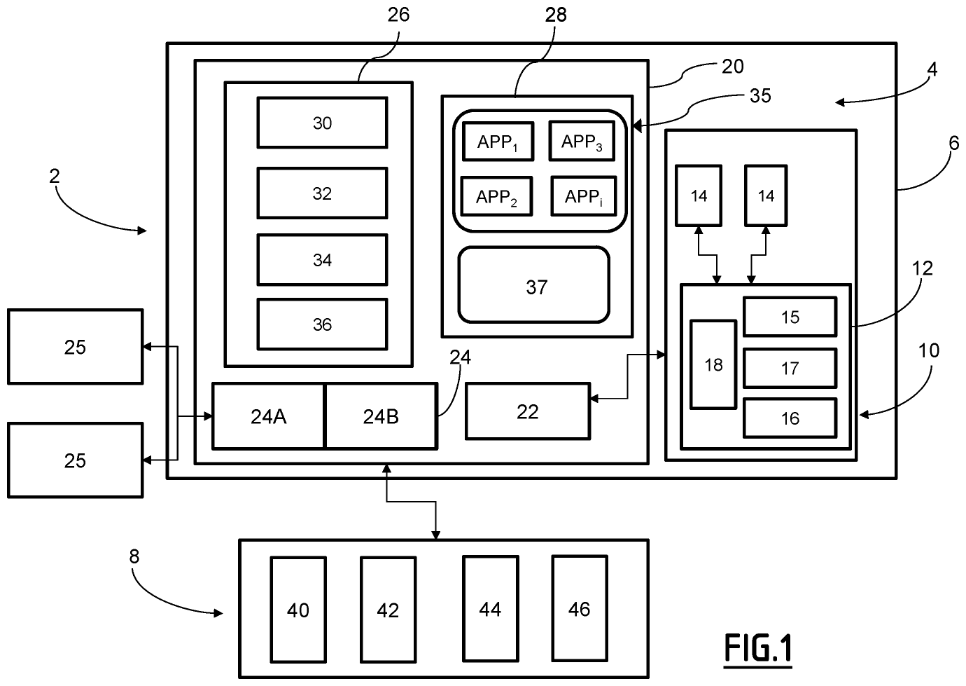

FIG. 1 schematically illustrates a system 2 which is an electronic execution system for onboard software.

The system 2 is a system used for air-to-ground cooperation.

The system 2 includes an onboard computation system 4, includes devices onboard an aircraft 6, and one or a plurality of ground computing systems 8.

The onboard computation system 4 includes a set 10 of onboard electronic devices with certified operation according to an avionics certification standard, comprising at least one onboard computer 12, and onboard equipment 14, e.g., sensors, cameras, radars, actuator, navigation system, autopilot system, flight controls, geolocation system, certified surveillance systems (traffic, terrain, weather), certified communication systems (e.g., radios).

For example, onboard devices with certified operation meet one or a plurality of the following standards: RTCA DO178B for the software certification level and RTCA DO160 for the hardware certification part, AEEC ARINC 702A for the flight management system, etc.

In one embodiment, the onboard computer 12 is configured for implementing certified software applications, e.g., applications for aid to navigation, for controlling the operation of the sensors 14 and for receiving and processing data from the sensors 14.

The onboard computer 12 includes hardware resources, more particularly a central processing unit comprising in particular one or a plurality of processors 15, suitable for executing computer program instructions when the processing unit is powered on. The onboard computer 12 further includes information storage units 16, comprising in particular random access memory (RAM) units, memory units such as ROM suitable for storing data and executable code instructions, a communication interface 18 and a human-machine interface 17.

In addition, the onboard computation system 4 advantageously includes an onboard edge computation device 20.

The edge computation device 20 may be advantageously used for increasing the onboard computation capacity, in a more flexible way, making possible easier and less expensive software and hardware updates than for the onboard computer 12.

The edge computation device 20 includes a first communication interface 22 configured for communicating, according to a first communication protocol, with the onboard electronic device or devices with certified operation, and in particular with the onboard computer 12.

More particularly, the first communication interface 22 is configured for communicating, according to a bidirectional communication, with the communication interface 18 of the onboard computer 12.

For example, the communication between the edge computation device 20 and the onboard computer 12 is a wired communication. In a variant, the communication between the edge computation device 20 and the onboard computer 12 is a wireless communication, e.g., such as by WiFi or Bluetooth.

Furthermore, the edge computation device 20 includes a second radio communication interface 24 configured for communicating, according to a second radio communication protocol, with the remote computation system or systems 8 located on the ground.

The second communication protocol is a radio communication protocol, e.g., a 4G or 5G mobile telephony standard protocol, the SATCOM satellite communication protocol, the Datalink AOC/ATC (Aeronautical Operation Control/Air Traffic Control) protocol.

According to variants, the edge computation device 20 comprises a plurality of second radio communication interfaces 24, according to a plurality of radio communication protocols, used for communicating with external devices, via a second radio communication interface 24A for communicating with the computation system 8 and a second radio communication interface 24B for communicating according to another radio communication protocol, e.g., with one or a plurality of external control devices 25, configured for sending commands to implement software applications by means of the edge computation device 20 and for receiving data, including data from onboard sensors, in return.

An external control device 25 is, e.g., a tablet, a portable computer, or a smartphone.

Such an external control device 25 is, e.g., also onboard the aircraft.

In one embodiment, such an external control device 25 is operated by an operator onboard the aircraft, e.g., a pilot of the aircraft, via a human-machine interface, e.g., a touch-screen or any other type of suitable human-machine interface (not shown herein).

Thereby, the edge computation device 20 is configured for communicating, bidirectionally, with the remote computation system 8 and with at least one external control device 25.

The edge computation device 20 further includes a processing unit 26, including one or a plurality of processors (CPU or GPU), and at least one electronic memory unit 28, such elements being suitable for communicating via a communication bus (not shown).

In the example shown in FIG. 1, only a processing unit 26 and an electronic memory unit 28 are shown.

The electronic memory unit 28 includes in particular memories such as RAM, ROM, any type of non-volatile memory (e.g., EPROM, EEPROM, FLASH, NVRAM).

The set of processing unit(s) 26 and electronic memory unit(s) 28 forms the local computation resources of the edge computation device 20.

Preferentially, the edge computation device 20 is modular, with a plurality of processing and memory units which may be added, which makes a dynamic increase in the available resources possible, as per the needs.

The dynamic increase in the available resources is limited, in practice, in certain embodiments, by the consumption of electrical energy and/or the total weight of such an edge computation device 20. Indeed, the total weight may be limited for certain types of aircraft, e.g., for drones, depending on the aerodynamic lift of the drone, and/or the maneuverability thereof. Similarly, the consumption of electrical energy when the edge computation device executes software applications with maximum occupation of computation and storage resources 26, 28, is to be taken into account, in order to ensure the completion of a planned mission, over an expected mission duration.

Herein, mission refers to a set of tasks to be performed, e.g., by onboard sensors, in connection with associated flight indications (trajectories, durations, waypoints, etc.).

The electronic memory unit 28 is configured in particular for storing a library of software applications 35, including a variable number of software applications APP₁, APP₂ . . . APPᵢ.

Each software application is stored in the form of an executable program code. The term “executable application” is also used for referring to such a software application.

For example, the software applications are obtained by downloading, from an external control device 25 or from a ground computation system 8.

In a variant or in addition, a software application APPᵢ may be obtained from a computer-readable medium, e.g., a medium apt to store electronic instructions and to be coupled to a bus of a computer system (e.g., USB key, non-volatile memory (e.g., EPROM, EEPROM, FLASH, NVRAM), a magnetic card, or an optical card).

Furthermore, the electronic memory unit 28 is also configured for storing data and results 37, in particular data obtained from onboard electronic devices with certified operation (e.g., images obtained from onboard sensors, operating data, data relating to the path or to the performance of the aircraft), and results obtained by the execution of the software applications APPᵢ. Such data and results 37 may be transmitted to the ground as “observability signals”, allowing a human operator or system to monitor the proper functioning of the overall system, perform debugging, and perform mission simulations or replay.

Furthermore, the electronic memory unit 28 is configured for storing parameters useful for the implementation of a method for executing software applications as described hereinafter, in particular parameters relating to the allocation of computation resources per software application, where appropriate, a table of execution priorities or a set of static rules defining execution priorities for software applications.

The processing unit 26 is configured for executing:
a module 30 for managing a plurality of software applications, the software applications being stored in the electronic memory unit 28, in particular in an application library 35, each software application being suitable for providing at least one control parameter and/or receiving at least one datum from at least one onboard electronic device with certified operation;
a module 32 for activating the execution of at least one of the stored software applications, configured for receiving at least one request for the execution of at least one executable application from an external control device and/or for validating an activation condition for the execution of at least one software application,
a management module 34 for managing an execution stack, configured for determining, for each software application to be executed, an allocation of local computation resources 26, 28 of the edge computation device 20 for executing all or part of the application to be executed, and for launching the local execution of the part of the application to be executed and for requesting, in the case where only a first part of the application is executed locally, a remote execution, by the remote computation system 8, of a second part of the application to be executed, complementary to the first part;
a data and results management module 36 configured for consolidating and storing the results, and for communicating the results to the external control device and/or the remote computation system.

The modules 30, 32, 34, 36 are suitable for cooperating, as described in greater detail hereinafter, for implementing a method for executing software applications, as described in more detail hereinafter.

In one embodiment, the modules 30, 32, 34, 36, are in the form of software instructions forming a computer program which, when executed by a computer, implements a method for executing software applications according to the invention.

The computer program including software instructions is further apt to be recorded on a non-transitory computer-readable medium. The computer-readable medium is, e.g., a medium apt to store the electronic instructions and to be coupled to a bus of a computer system. As an example, the readable medium is an optical disk, a magneto-optical disk, a ROM memory, a RAM memory, any type of non-volatile memory (e.g., EPROM, EEPROM, FLASH, NVRAM), a magnetic card or an optical card.

In a variant (not shown), the modules 30, 32, 34, 36 are each in the form of programmable logic components, such as FPGAs (Field Programmable Gate Array) microprocessors, GPGPU (General-purpose processing on graphics processing) components, or further in the form of dedicated integrated circuits, such as ASICs (Application Specific Integrated Circuit).

The edge computation device 20 is thereby configured for locally executing a first part of the applications to be executed, and for delegating, where appropriate, a second execution part to the remote computation system 8. In some cases, the first part is equal to 100% of the software application to be executed, in which case there is no need to delegate a second execution part to the remote computation system.

In one embodiment, the remote computation system 8 includes one or a plurality of interconnected electronic computation devices.

In a variant, the remote computation system 8 includes or is connected to a cloud of computers generally referred to as a “cloud”.

In a functional representation, the remote computation system 8 includes a processing unit 40, including one or a plurality of computation processors, an electronic memory unit 42, a ground communication interface 44, suitable for communicating with the second communication interface 24 of the onboard edge computation device 20, and a human-machine interface 46.

The processing unit 40 is configured for executing parts of the software applications APPᵢ, by executing a corresponding part of the executable code, stored in the electronic memory unit 42, upon request from the edge computation device 20, to store data and computation results and to transmit the computation results, via the communication interface 44, to the edge computation device 20 and/or to an external control device 25.

According to one variant, the remote computation system 8 located on the ground is also configured for transmitting data and computation results to another aircraft 6, e.g., in the context of a mission involving a plurality of aircraft.

Advantageously, such a management of execution stack is dynamic and flexible and makes it possible to take into account one or a plurality of criteria among: a criterion of availability of computation resources, a criterion of connectivity, a criterion of criticality of the data, a criterion of priority, as explained in greater detail hereinafter.

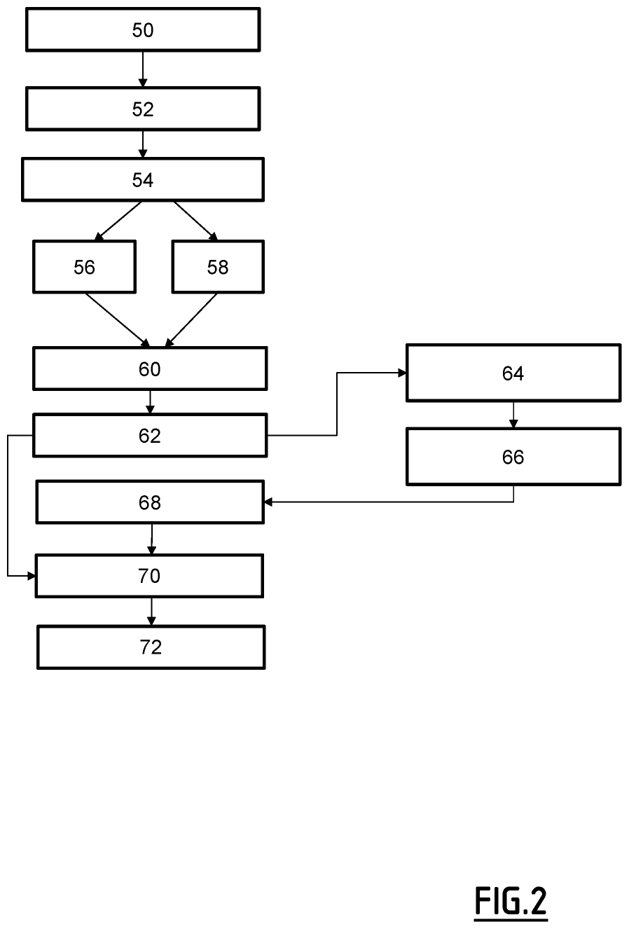

FIG. 2 is a block diagram of the main operations of a method for executing software applications, implemented in the electronic system 2 for executing software applications, in a first embodiment.

As will become more clearer from the following description, the method includes a set of operations implemented by a processing unit, comprising at least one processor, of an onboard edge computation device 20. Such operations are executed after the edge computation device has been powered up.

The method includes an initialization operation 50, which is a preliminary step, executed in a time that is delayed with respect to the other steps of the method.

More particularly, during the initialization step, the first and second communication interfaces are initialized, more particularly configured with respective communication addresses, so as to make communication possible with, on the one hand, the onboard electronic devices 10 with certified operation, and, on the other hand, with the external devices 25 and with the ground computation system 8.

Alternatively, the edge computation device executes the initialization of the communication interfaces following a request, e.g., transmitted by an operator or by an external application via an external control device 25.

Moreover, during the initialization operation 50, at the initialization of the first communication interface with the onboard equipment, first configuration structures, e.g., first configuration tables, are received from at least one onboard computer 12, and stored in a local electronic memory unit of the edge computation device.

Similarly, at the initialization of the second communication interface with the remote computation system, second configuration structures, e.g., second configuration tables, are received from at least one remote computation system 8, and stored in a local electronic memory unit of the edge computation device.

The first and second configuration structures contain in particular connectivity information (e.g., identifiers and communication addresses).

Optionally, during the initialization step, the software application library APPᵢ is re-initialized.

Optionally, the data and result 37 stored in the memory unit of the edge computation device are erased during initialization 50.

According to variants, the applications APPᵢ and/or the data and results stored during a prior use of the edge computation device are preserved.

Furthermore, during the initialization phase, in one embodiment, parameters useful for implementing the method for executing software applications are obtained and stored. Such parameters include in particular parameters relating to the allocation of resources per software application, e.g., for a minimum allocation per software application, a maximum allocation or an average allocation, and/or a table of execution priorities or a set of static rules defining execution priorities of software applications.

The resource allocation parameters contain, e.g., a computation power, e.g., expressed in processor clock frequency (e.g., GHz), and/or an associated storage capacity, expressed, e.g., in kilobytes, and/or a percentage of a first communication bandwidth with the onboard electronic devices with certified operation, and/or a percentage of second communication bandwidth with the remote computation system.

In one embodiment, the resource allocation parameters are grouped in a parameter vector, containing a value for each of the parameters listed below:
P1: allocated computation power;
P2: allocated storage capacity;
P3: percentage of first communication bandwidth; and
P4: percentage of second communication bandwidth.

In variants, a vector including only a subset of the allocation parameters is defined.

In another variant, only one of the aforementioned parameters is used.

The method includes an operation 52 of receiving a command to add/delete a software application, coming from an external control device, or from the ground computation system or from one of the onboard devices.

Preferentially, a deletion command is received from an external control device or from an authorized operator, e.g., the owner of the software application to be deleted.

For example, an authentication of authorized operator is implemented, by means of an authentication method, many variants of such authentication methods being known.

According to one embodiment, the addition/updating of an application is performed by an operator, preferentially an authorized operator, by means of a data storage medium (e.g., USB key).

Upon reception of such a command, the method includes an operation of managing applications 54, which updates the library of software applications according to the commands received.

The operation 54 comprises the reception of a new software application or an update of a previously stored software application, by means of a wired link or to be dataloaded by means of a radio communication link, then the storage of the new applications APPⱼ, and/or removal of the applications APPᵢ from the application library.

The software applications stored in the application library 35 are suitable for providing at least one control parameter and/or receiving at least one datum from at least one onboard electronic device.

As an optional addition, following the reception of a new software application or of an update of an existing software application, the method implements validations of integrity and validity of downloaded applications, by usual methods (authentication, cyclic redundancy check (CRC) validation, etc.).

Thereafter, the method includes the activation of the execution 56 of one or a plurality of the stored software applications, which then become software applications to be executed.

Indeed, the parallel execution of a plurality of software applications is managed.

The activation of execution is based on either the reception of a request to execute at least one software application from an external device, or the validation of a condition of activation of execution.

In the case of the validation of a condition of validation of execution, activation is automatic.

For example, the condition of validation of execution of a software application APPᵢ is the end of execution of a software application APPⱼ or corresponds to a decrease in the resource requirement of the software application APPⱼ compatible with the operation thereof.

Furthermore, commands for pausing or stopping the execution of one or a plurality of software applications can also be received (operation 58), the management being performed directly.

Stopping an execution makes it possible to free resources and thus redistribute the available resources. Like for execution, an automatic validation of a stop condition makes it also possible to initiate the stopping or pausing the execution of an application.

The operations 54, 56, 58 are preferentially executed in the background, substantially in parallel, so as to constantly take into account the reception of new software applications or the updating of existing software applications, as well as the activations of execution and the execution stop or pause commands.

The method further includes an operation 60 of managing an execution stack of the software applications to be executed. Such step is repeated regularly, at predetermined time intervals or upon an event (e.g., a request to start a new application, an event that terminates or significantly modifies the needs of computational resources of an application).

The management step 60 implements, for each application to be executed APPₖ, an allocation of resources, more particularly computational resources (processor and memory) of the edge computation device, called local resources, for executing all or part of the application to be executed APPₖ.

For example, in one embodiment, the same quantity of local resources is allocated to each APPₖ, the quantity being predetermined during the initialization operation 50.

According to one variant, the resources are allocated dynamically, e.g., according to an expected response time per application, which makes it possible to dynamically define execution priorities.

According to an alternative, the allocation of resources is performed according to priorities, defined in a previously recorded table of execution priorities or according to a previously programmed set of static rules.

According to a variant, the priorities are dynamically updated by means of an external controller.

Thereby, the management module also implements a priority criterion.

For each software application Apl to be executed, depending upon the resources required for the execution thereof, it is possible to determine, where appropriate, a first part of the application APP_{k,1} which is executed locally, and a second part APP_{k,2}, complementary to the first part, to be executed by the remote computation system on the ground.

In other words, local resources and remote resources are allocated for the execution of the same software application APPₖ.

Thereby, a criterion of availability of computational resources is implemented for the determination of the local or remote execution of each software application.

In addition, the availability of communication bandwidth with the ground computation system is also taken into consideration. Thereby, a connectivity criterion is taken into account.

For example, for software applications that use high-speed data, e.g., video data, a large bandwidth is needed for processing the data by the remote computation system located on the ground. Moreover, for a moving aircraft, the communication conditions according to the second radio communication protocol may vary according to the movement, the meteorological conditions, etc.

Let us consider, e.g., a drone for detecting and mapping obstacles such as electric pylons, and the mission of which consists in flying over a determined geographical area, detecting obstacles such as “pylons”, characterizing the pylons (width, height), geo-referencing same (i.e., computation the geographical position thereof in a given frame of reference), and deduce therefrom the mesh of electrical cables that connects the pylons.

Detection can be done using cameras onboard the drone, the resolution, field width and shooting speed of which will have a direct impact on the need for resources. For example, a video sequence in 4K resolution/definition, wide field, at 50 frames/s will require much more storage resources (RAM/ROM) and CPU (or GPU) resources for the processing thereof, than a video sequence with low resolution (e.g., 480 p), or with a smaller field width or at 25 frames/s.

The power consumption, and hence the autonomy of the drone, depend directly on the demand of CPU/RAM/ROM.

In the case of a distributed computation between the local application APP_{k,1,} and, the application to be executed by the remote computation system on the ground APP_{k,2}, the power consumption of the drone will also depend on the communication bandwidth between the aircraft and the ground, and the quality of the network, which conditions the means of communication used and the power required for the power supply to the transmit and receive antennas.

If the computation (CPU/GPU) and/or storage (RAM/ROM) capacity is sufficient for processing a 4K video sequence (criterion 1), and if the power consumption is compatible with the target flight time of the drone (criterion 2), the system may choose to have all the mapping and detection and geo-referencing computations performed locally by the application APP_{k,1}.

If the computation (CPU/GPU) and/or storage (RAM/ROM) capacity is insufficient for processing a 4K video sequence (criterion 1), and if the power consumption is compatible with the target flight time of the drone (criterion 2), the system may choose to have the mapping and detection and geo-referencing computations performed locally by the application APP_{k,21} by sending to the ground device the images taken locally by the camera.

If the computation capacity (CPU/GPU) and/or storage capacity (RAM/ROM) is sufficient for processing a 4K video sequence (criterion 1), but the power consumption is incompatible with the target flight time of the drone (criterion 2), the system may choose between a plurality of solutions:
If the power consumption is too high due to the processing of all the images onboard (CPU/RAM/ROM), but the power consumption for sending the images to the ground is not too high (e.g., if the communication link is of good quality), the system may choose to have some of the mapping and detection and geo-referencing computations performed locally by the application APP_{k,1} and another part by the application APP_{k,2}, by sending to the ground device some of the images taken locally by the camera.
If the power consumption is not too high due to the processing of all the images onboard (CPU/RAM/ROM), but the power consumption for sending the images to the ground is too high (e.g., if the communication link is of good quality), the system may choose to have all the mapping and detection and geo-referencing computations performed locally by the application APP_{k,1}. There will be no sending of images to the ground.
If the power consumption is too high due to the processing of all the images onboard (CPU/RAM/ROM), and the power consumption for sending the images to the ground is also too high (e.g., if the communication link is of lower quality), the system may choose to switch to a lower image resolution, or to store images longer, while waiting to regain a better bandwidth.
If the computation (CPU/GPU) and/or storage (RAM/ROM) capacity is insufficient for processing a 4K video sequence (criterion 1), but the power consumption is compatible with the target flight time of the drone (criterion 2), the system may choose to have all the computations performed by the application APP_{k,2}, by sending to the ground device the images taken locally by the camera.
Finally, if the computation capacity (CPU/GPU) and/or storage capacity (RAM/ROM) is insufficient for processing a 4K video sequence (criterion 1), and if the power consumption is incompatible with the target flight time of the drone (criterion 2), switch to a lower resolution and repeat the above operations.
If there is no solution, even for the lowest possible resolution, the system may deactivate the application APPₖ, and record an error message to be sent to the ground.

The first and second parts to be executed locally/remotely respectively are defined e.g., in terms of the percentage of code to be executed.

In some cases, the first part is equal to 100% of the application to be executed, in which case there is no need to move part of the execution to the ground computation system.

Preferentially, the software applications are coded so that the applications can be executed by parts.

In one embodiment, all or part of each software application is also stored beforehand in the electronic memory 42 of the remote computation system 8, which facilitates the delegation of computations.

In one embodiment, a criterion of data criticality is implemented in order to determine the second part APP_{k,2}, to be executed on the ground, thus making it possible to avoid transmitting data or results considered sensitive or confidential to the ground computation system, via the second transmission interface.

Such data considered to be confidential, and hence to be protected are, e.g., data relating to the performance of the aircraft, or else confidential data of the customer who owns the application to be executed (e.g., airline, institution, company).

More particularly, as a result, it is possible to limit any transmission of data associated with a critical flight or mission phase.

In the case where a second part of a software application is to be executed by the remote computation system, the method includes a remote execution request 62, including the transmission of associated information (e.g., execution point, data to be used, intermediate results).

In a variant, in the absence of prior storage in an electronic memory unit of the remote computation system, the executable code forming the second part APP_{k,2}, complementary to the first part, to be executed by the remote computation system, is transmitted to the remote computation system during the operation 62.

The remote computation system executes the second software application part APP_{k,2} (operation 64), and transmits the results of the computations to the onboard edge computation device (operation 66).

The edge computation device receives the results during the operation 68.

In one embodiment, the results are consolidated during the consolidation operations 70.

For example, the consolidation includes temporal and/or spatial synchronization of the results, and/or a data merging, e.g., inertial sensor data merging with positions calculated by a software processing on the basis of data from cameras.

Following the consolidation operation 70, the consolidated results are stored and/or transmitted (operation 72) to the external control device, which initiates the execution of the software application.

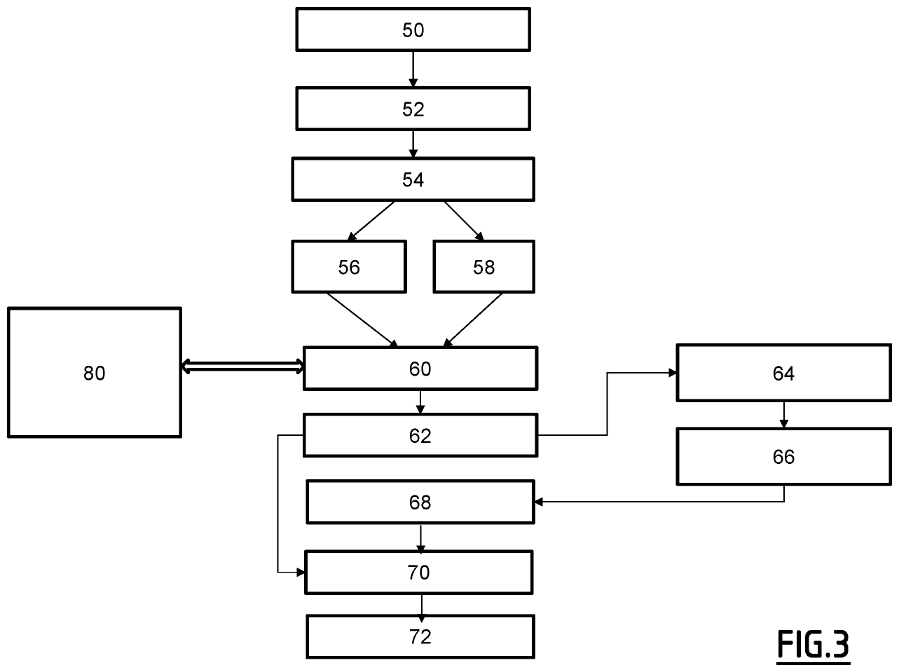

FIG. 3 illustrates a second embodiment of the method for executing applications, as implemented in the application execution system 2.

In the second embodiment of the method for executing applications implemented in the application execution system 2, a supervision device, which is either one of the external control devices or the remote computation system on the ground, implements real-time supervision of the operation of the onboard edge computation device.

Preferentially, the supervision device forms part of the remote computation system on the ground and includes a human-machine interface, for the display of information intended for an operator and the reception of commands from the operator.

In such embodiment, in addition to all the steps described hereinabove and which are not described again herein, the method includes a supervision 80 implemented by the supervision device.

The supervision 80 is performed continuously, the supervision device including a human-machine interface and being configured for receiving observability signals from the edge computation device 20.

In such embodiment, observability signals of the edge computation device, comprising data relating to local computation resources and information relating to the execution of at least one of the software applications, are sent to the supervision device. Observability signals include in particular information about the use of local resources of the edge computation device and the stack of applications to be executed/being executed.

The supervision device is configured for calculating a state of operation of the edge computation device and a state of execution of the or of each software application from the received observability signals.

The supervision device then implements, e.g., displays on the human-machine interface, representative of the state of operation of the edge computation device (state of local resources, connectivity) and the state of execution of the applications, optionally in addition to the data and result of the applications. In one embodiment, the displays follow, substantially in real-time, the operation of the edge computation device. As a result, an operator may define execution priorities in real-time, which makes it possible to prioritize the execution of certain software applications and to place other software applications in low priority or pause, and/or to modify in real-time the resource allocations.

Commands relating to the priorities of execution of the software applications and/or modifications of the allocation of resources are then transmitted via the supervision device to the onboard edge computation device.

In one embodiment, supervision extends to all onboard devices, including operating devices with certified operation, thereby providing overall supervision of the use of onboard resources. Indeed, via the onboard edge computation device, data supplied by sensors or onboard devices are also transmitted to the supervision device, for display.

In addition, in one or other of the embodiments described hereinabove, provision is made to record, e.g., in execution reports (e.g., files, tables) or any other appropriate data structure, in an appropriate format, a set of status and execution information of the edge computation device and of the onboard electronic devices with certified operation, as well as additional information including information on the environment and information on connectivity, over the full duration of the aircraft mission.

For example, the set of information includes all the states of the execution stack, and the computational/hardware resources of the edge computation device, e.g., the software applications being executed, the description of the computational resources allocated, the data and results, as well as additional information such as: the weather conditions, the availability of communication interfaces, the bandwidth available for communications with the ground computation system, data on the internal operation of the systems, the energy consumption of each application and of other aircraft systems, and the flight profile.

The performance report(s) containing all such information is sent to the ground supervision device.

Such execution reports may then be used for carrying out a subsequent replay phase, executed on the ground by the supervision device. The supervision device is configured for displaying, in cooperation with graphical representation mechanisms on the human-machine interface, a complete conduct of the mission (replay), in particular successive states of the edge computation device and, optionally, of the onboard electronic, which allow maintenance and debug operations to be carried out. Among other things, such a replay phase may also be used for recalculating the parameters supplied during the initialization step 50 such as the minimum, maximum or average allocation of the resources of the edge computation device.

By means of the application execution system described, the onboard hardware resources of an aircraft (computation resources, memory) are increased dynamically and flexibly, and the implementation of client software applications is then possible, while ensuring the security of execution.

Advantageously, an aircraft carrying an edge computation device as described may be used as a mobile data capture means, like satellites.

Advantageously, the presence of an onboard invention makes it possible to perform computations with complex algorithms, which would not be feasible by certified onboard devices because of the limitations imposed by the certifications.

Advantageously, the flexibility imparted by the possibility of moving parts of the execution of the applications to the ground makes it possible to adapt to the constraints of the aircraft, in particular the constraints on onboard weight and electrical energy consumption.

1. An onboard edge computation device, comprising:
a first communication interface configured for communicating, according to a first communication protocol, with at least one onboard electronic device with certified operation;
a second radio communication interface, configured for communicating, according to a second radio communication protocol, with a remote computation system located on the ground;
at least one electronic memory unit; and
at least one processor forming local computation resources, the at least one processor configured for implementing:
a module for managing a plurality of software applications stored in the at least one electronic memory, each software application being suitable for providing at least one control parameter and/or for receiving at least one datum from at least one onboard electronic device with certified operation;
a module for activating execution of at least one of the stored software applications, configured for receiving at least one request for execution of at least one software application from an external control device and/or for validating an activation condition for execution of the at least one software application; and
a management module for an execution stack, configured for determining, for each software application to be executed, an allocation of local computation resources of the edge computation device, in order to execute all or part of the software application to be executed, and for launching the local execution of the part of the application to be executed, and for requesting, in the case where a first part of the application is executed locally, a remote execution, by the remote computation system, of a second part of the application to be executed, complementary to the first part.

2. The device according to claim 1, wherein the management module for the execution stack implements, for the determination of local computation resources allocated per application to be executed, at least one among: a criterion of availability of computation resources, a criterion of connectivity, a criterion of data protection, and a criterion of priority.

3. The device according to claim 1, configured for dynamically receiving from an external control device at least one parameter of allocation of computational resources and/or of connectivity and/or of priority of execution.

4. The device according to claim 1, further comprising a data and results management module, configured for consolidating and storing results obtained by the execution of each software application, for communicating the results to the external controller and/or to the remote computation system.

5. The device according to claim 1, wherein the module for managing the plurality of software applications is configured for downloading new software applications or an update of a previously stored software application, and/or for deleting a previously stored software application.

6. An electronic software application execution system comprising:
an onboard computation system on an aircraft, comprising:
an edge computation device according to claim 1; and
at least one onboard electronic device with certified operation according to an avionics certification standard; and
at least one remote computation system located on the ground.

7. The system according to claim 6, wherein said at least one remote computation system comprises a supervision device, the supervision device including a human-machine interface and being configured for:
receiving observability signals from said edge computation device, the observability signals comprising data on local computation resources and information on the execution of at least one of the software applications;
calculating a state of operation of said edge computation device and a state of execution of the at least one software application from the received observability signals; and
displaying the state of operation and the state of execution on the human-machine interface.

8. The system according to claim 7, wherein said edge computation device is configured for:
recording, during a mission of the aircraft, a set of information in at least one execution report, comprising status and execution information of said edge computation device and of said onboard electronic devices with certified operation, as well as additional information comprising information on the environment and information on connectivity; and
sending the execution report to said supervision device, said supervision device being further configured for executing and displaying on the human-machine interface a replay of the states of said edge computation device and of said at least one onboard electronic device.

9. A method for executing software applications implemented by an electronic system for executing software applications according to claim 6, comprising:
receiving a command to add/delete a software application, coming from an external control device, or from the ground computation system or from one of the onboard devices;
updating a storage of software applications according to the command received; and
activating the execution of one or a plurality of the stored software applications, based either on the reception of a request to execute at least one software application from an external device, or on the validation of a condition for activation of execution and/or pause or stop of execution of one or a plurality of software applications upon reception of a command or automatic validation of a stop condition.

10. The method according to claim 9, further comprising:
managing a stack of applications, implementing, for each software application to be executed, an allocation of local computational resources for executing a first part of the software application, and
in the case where the first part is less than 100%, sending a command to execute a second part of the software application, complementary to the first part, to the remote computation system.

11. A computer program including software instructions which, when executed by a programmable electronic system, implement a method for executing software applications according to claim 9.
